(19) United States
(12) Patent Application Publication
(10) Pub. No.: US 2008/0087721 A1
(43) Pub. Date: Apr. 17, 2008

(54) Identification Card

(75) Inventors: Albert Jos, J.M. Van Breemen, Eindhoven (NL); Harmannus Franciscus Schoo, Eersel (NL); Victor Robert Bochno, Valkenswaard (NL); Karl Everhardus Sewalt, Schiedam (NL)

Correspondence Address: MICHAELSON & ASSOCIATES, P.O. BOX 8489, RED BANK, NJ, 07701, US

(73) Assignee: Nederlandse Organisatie voor toegepastnatuurwetenschappelijk Onderzoek TNO, V K Delft (NL)

(21) Appl. No.: 10/571,860

(22) PCT Filed: Sep. 14, 2004
(86) PCT No.: PCT/NL04/00637

§ 371 Date: Nov. 6, 2007

(30) Foreign Application Priority Data
Sep. 18, 2003 (NL) 1024323

(51) Int. Cl. G06K 19/077

(52) U.S. Cl. 235/380; 283/75; 283/91; 283/94

(57) ABSTRACT

Identification card, comprising a card body (1) with graphic identification information, wherein light emission means emit the identification information in visible or invisible light. The light emission means can consist of a flat light emitting diode (2) (FLED), for instance a Polymer FLED. The FLED can be connected with an internal or external electrical source. One or more layers (8 . . . 13) of the FLED that are needed for light emission can contain the graphic identification information or a part thereof, that is, the graphic identification information can be contained in the shape of that layer or layers and/or in the composition thereof. The graphic identification information can also be contained in the shape and/or intensity of the electrical field in, and the electrical current through, those layers (12), respectively, as effected by the electrical source.

### FIELD OF THE INVENTION

The invention relates to an identification card, comprising a card body with graphic identification information, as well as an identification system suitable for cooperation with such an identification card.

### BACKGROUND OF THE INVENTION

Identification cards comprising a card body with graphic identification information are commonly known. To be considered here are, for instance, identification passes, credit cards, etc. The graphic identification—alphanumeric and/or other signs or codes—is normally provided on the outside of the card body in the form of imprint, relief print and/or holograms. Other, non-graphic identification information can consist of codes, etc., that may be stored in a magnetic strip provided on the card body, or in a memory or microprocessor to be accessed via contacts or wirelessly. In the context of this application, graphic information is understood to mean alphanumeric and/or non-alphanumeric images, signs or codes which can be perceived or detected in the optical domain—by means of visible or invisible (infrared, ultraviolet, etc.) light.

Since such information is normally provided on the outside of the card body, that information—in particular where it is used for identification, access control, etc.—is susceptible of undesired manipulation and falsification from outside, to which problem the present invention seeks to provide a solution.

### SUMMARY OF THE INVENTION

The invention proposes an identification card, comprising a card body with graphic identification information, light emission means which, under particular conditions, are suitable for emitting the identification information in visible or invisible light, which light emission means comprise an electrical source-connectible, substantially flat light emitting diode, hereinafter designated by FLED, which comprises one or more layers needed for light emission, which contain at least a part of the graphic identification information.

A first aspect is that the identification information can be made visible under particular conditions, which creates the possibility of having the identification card cooperate with an identification device which is suitable to make identification information perceptible only when the card cooperates with the device.

A second aspect is that the identification information, if desired, can be emitted in the form of invisible—infrared or ultraviolet—light, which also constitutes a certain barrier against manipulation and/or falsification.

The light emission means can be preferentially formed by a substantially flat light emitting (or electroluminescent) diode, hereinafter designated by FLED (not to be confused with “Flashing Light Emitting Diode”), such as a Polymer LED (PLED), an Organic LED (OLED) or a “Small Molecule” Organic LED (SMOLED).

The specific graphic identification information can be provided by providing one or more layers of the FLED that are necessary for light emission—such as anode(s), cathode(s) and/or intermediary luminescence/emission layers, etc.—with such identification information. The information can for instance be determined by the shape of one or more of those layers and/or by the composition of the respective layer or layers, which determine, for instance, the color of the light. It is then possible that the graphic information is determined substantially by the shape and/or composition of a single layer, or by a combination of the shape and/or composition of more layers. Those layers can (partly) cooperate with each other or be independent of each other.

The graphic identification information, besides being embodied by the shape and/or material properties/composition of the different layers, can also be contained in the shape and/or intensity of the electrical field in the respective layers as effected by the electrical source, and the electrical current through the respective layers as effected by the electrical source, respectively. For instance, the shape in which the light is emitted is determined by the shape of the mutual projection of the anode(s) and cathode(s) and/or the shape(s) of the intermediate layer or layers such as emission, coating, covering and/or reflection layer or layers, etc.

For activating the FLED, the identification card can comprise an internal electrical source, for instance a flat miniature battery or accumulator. Also, the identification card can comprise means—for instance galvanic contacts—for connecting the FLED with an external electrical source. The two options are possible at the same time, with the internal electrical source for instance being recharged from the external source.

It is noted that in the field of the invention the following publications give relevant background information.

US-A1-2003/062830 relates to the mechanical construction and reinforcement of thin, flexible OLED devices;

EP-A-0831420 relates to information stored on a card being rendered readable to the human eye by means of optical components;

US-A1-2002/181208 relates to the assembly of electronic devices—among which a display—on a substrate; and

DE-C-19923138 relates to the integration of displays into cards on the basis of printing/laminating processes.

Hereinafter, the invention is set out in more detail with reference to a few exemplary embodiments.

### DRAWINGS

FIG. 1 shows an identification card according to an exemplary embodiment of the invention.

FIG. 2 shows an exemplary embodiment of an identification and access system with which the identification card can cooperate.

FIG. 3 shows in more detail the structure of the identification card of FIG. 1.

### DESCRIPTION OF THE DRAWINGS

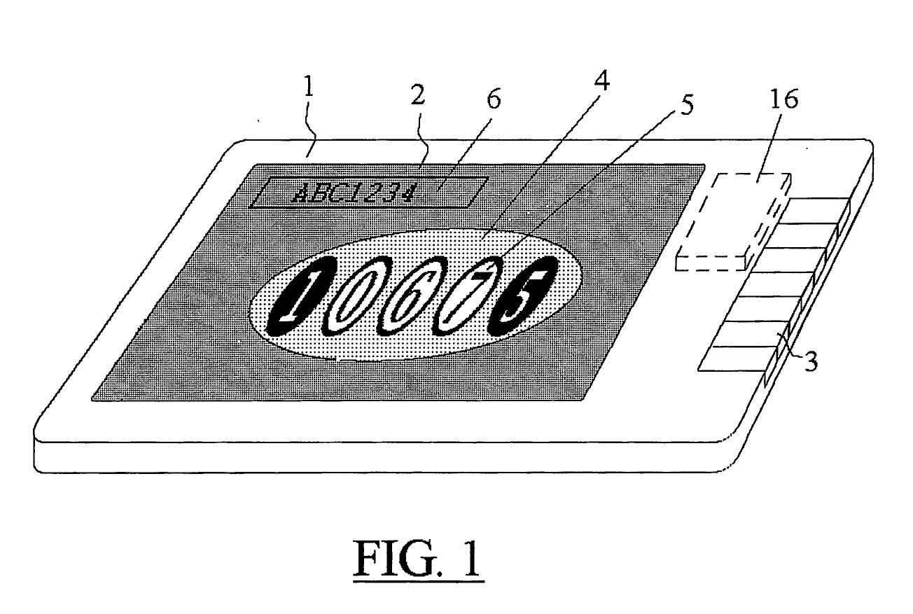

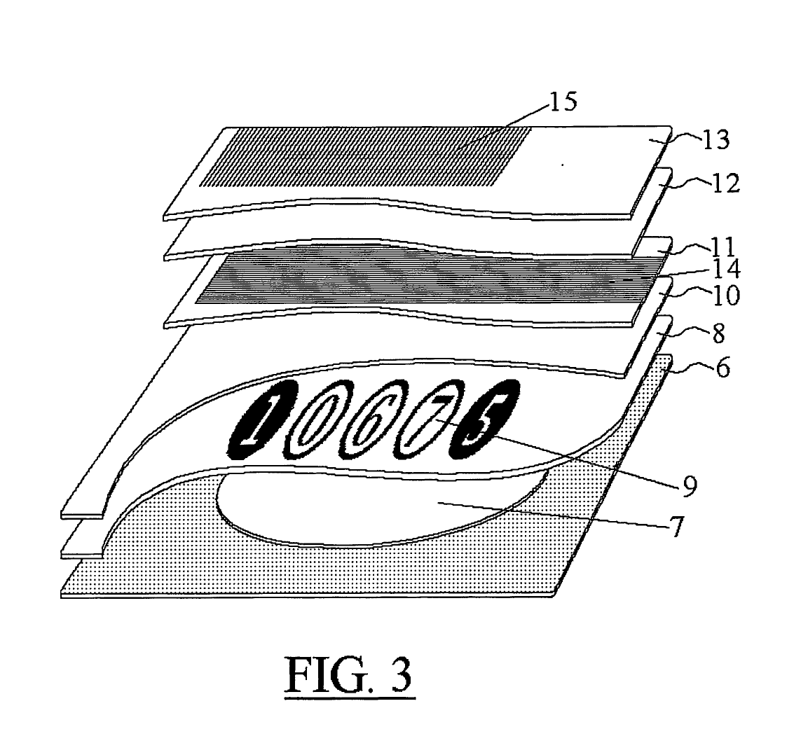

FIG. 1 shows an identification card, comprising a card body 1 in which graphic identification information can be shown by means of a FLED 2, suitable for light emission, which is built up from different layers and will be discussed in more detail hereinafter with reference to FIG. 3.

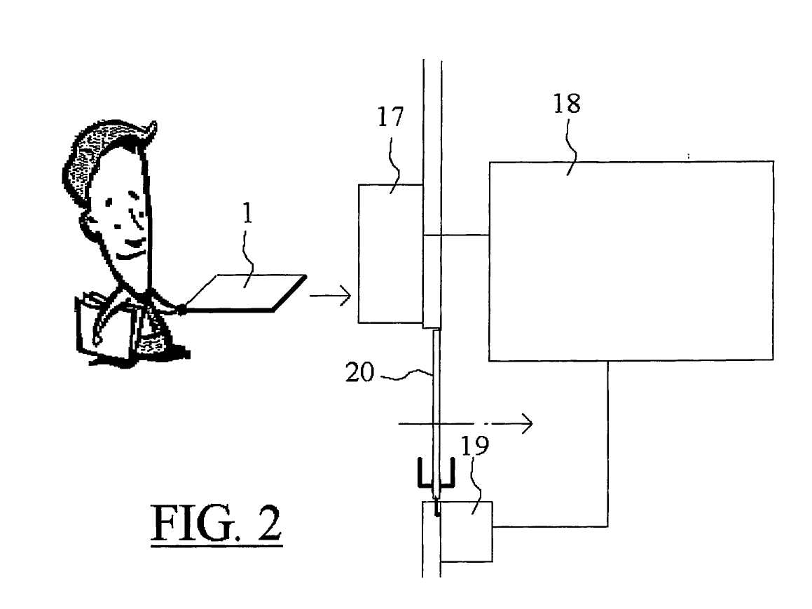

The FLED 2 in this exemplary embodiment is of multiple design and I5 comprises different identification areas 4, 5 and 6, which can be read out and processed by a card reader 17, shown in FIG. 2, of an identification system 18. In FIG. 2, the identification system 18 is used for (inter alia) access control: the card body 1 is put into the card reader 17 by a person desirous of access to a protected space. The card reader 17 reads out the identification area used for access control, for instance the area 6, and transmits that information as read out (optically, for instance in the form of infrared light) to the identification system 18, which compares that information with access information previously stored in the system 18, for instance: “card with access code (in area 6) ABC1234 has access to the space behind the door 20 which is locked with locking device 19”. Thus, the system 18 transmits an “unlock” code to the locking device 19, after which the person—after having taken his card 1 from the reader—is given access to the respective space via the door 20.

Returning to FIG. 1, the area 4 represents a background in a particular color, area 5 a number of identification characters “10675” in a particular font (the “1” and the “5” inverted) and color, and area 6 an alphanumeric display in, if so desired, yet another color. The identification information in the areas 4, 5 and 6 can be made visible by connecting contacts 3 with electrical supply contacts provided in the card reader 17 (FIG. 2), so that the FLED 2 is activated only if it is in the card reader 17 (which means an additional protection from “card fraud”).

The different areas 4, 5 and 6 can emit light of mutually different wavelengths, in the visible as well as in the invisible spectrum.

It is also possible not to supply the FLED 2 from an external electrical source, but (possibly partly) from an electrical source incorporated into the card body 1 which is rechargeable for instance via the contacts 3 or via a light collector (not shown), so that the identification information is also visible if the card has no connection with the respective reader.

The specific graphic identification information can be provided by providing one or more layers of the FLED that are needed for light emission—such as anode(s), cathode(s) and/or intermediary luminescence/emission layers, etc.—with such identification information. The information can for instance be determined by the shape of one or more of those layers and/or by the composition of the respective layer or layers, which determine, for instance, the color of the light. It is then possible that the graphic information is determined substantially by the shape and/or composition of a single layer, or by a combination of the shape and/or composition of more layers. Those layers can partly cooperate with each other and/or be partly independent of each other. By way of illustration, the exemplary embodiment shown in FIG. 3 comprises a cathode 6 on which a light emitting polymer (LEP) 7 is provided in the form of the area 4 in FIG. 1. Situated above the cathode 6 is a light-transmitting anode 10. When the cathode 6 and anode 10 are connected with a voltage source, the LEP 7 emits light in the direction of the anode 10 and, since the latter is light-transmitting, further to outside the FLED 2.

Situated between the cathode 6 and the anode 10 is a second LEP layer 8. The composition thereof may be different from that of the LEP layer 7, so that it emits a different color of light. On the LEP 8, the identification characters “10675” have been provided, for instance by means of an opaque lacquer layer or by means of a chemical etching process or by a laser treatment whereby the light emitting material properties of the LEP 7 have been inactivated in the form of the respective characters. Under the influence of the electrical field between the cathode 6 and the anode 10, the thus processed LEP 8 emits light in the direction of the anode 10, thereby also rendering the identification characters “10675” visible.

Accordingly, the graphic identification information, besides being embodied by the shape and/or material properties/composition of the different layers, can also be contained in the shape and/or intensity of the electrical field in the respective layers as effected by the electrical source, and the electrical current through the respective layers as effected by the electrical source, respectively. In the exemplary embodiment shown, the shape in which the light is emitted is determined by the shape of the LEP coating 7 and LEP layer 8 situated between the cathode 6 and anode 10. Clearly, the shape of the cathode 6 and the anode 10 also determines the shape of the surface of light that is radiated upwards via the anode 10, since the shape of the electrical field between the cathode 6 and the anode 10 is determined by the shape of the projection of those two electrodes 6 and 10.

Alternatively, or additionally, use can be made of emitting, via the FLED 2, identification (and/or other) information which is not inherent in the form of cathode 6, anode 10 and/or intermediary LEP layers, as with the system of the layers 6 to 10, but which is “drivable” from, for instance, a microprocessor 16 included in the card body 1. That microprocessor 16 for instance can in turn be driven from the identification system via the contacts 3. The respective identification information or other information, represented in FIG. 1 by the series of characters “ABC1234”, is emitted by a LEP layer 12 which is situated between a layer 11, provided with a matrix of cathode lines 14 individually connectible by the microprocessor 16 with the negative pole of an electrical source, and a layer 13, provided with anode lines 15 individually connectible by the microprocessor 16 with the positive pole of the electrical source. The characters to be emitted, in the figure: “ABC 1234”, result from the electrical fields (and the electric currents, respectively) between respective projections (nodes) of the cathode and anode lines 14 and 15 connected with the electrical source, as a result of light emission of the LEP-layer 12, at those so activated cathode-anode-matrix nodes.

The different layers 6 to 13 and the structures provided thereon can be fabricated in a known manner and be assembled into an integrated, multiple FLED 2 which is useful for application as identification card with advanced possibilities of use and improved security aspects.

Finally, it is noted that the graphic identification information can take a variety of forms, not only the form of alphanumeric characters, as in the foregoing example, but also the form of, for instance, biometric patterns useful for identification, such as those of “fingerprints”, etc. Such biometric patterns can be recorded in a fairly simple manner and be subsequently used for producing a corresponding pattern on, for instance, a LEP layer 8. Such production can be done by analog route, for instance by means of a well known process of projecting and etching the pattern on the LEP layer 8. If the pattern is recorded digitally, another possibility is available, viz. representing the pattern by means of the matrix formed by the cathode and anode lines 14, 15 in the above-discussed exemplary embodiment. The node parameters (inter alia regarding the luminance) of the respective digitized biometric pattern are supplied to the driver 16, which in turn converts these parameters to electrical voltage on the different cathode line/anode line combinations.

1. An identification card, comprising a card body with graphic identification information, light emission means which, under particular conditions, are suitable for emitting the identification information in visible or invisible light, which light emission means comprise an electrical source-connectible, substantially flat light emitting diode (2), hereinafter designated by FLED, which comprises one or more layers (8 . . . 13) needed for light emission, which contain at least a part of the graphic identification information.

2. An identification card according to claim 1, wherein the FLED is a Polymer FLED.

3. An identification card according to claim 1, wherein the FLED is an Organic FLED.

4. An identification card according to claim 1, wherein the graphic identification information is contained in the shape of the respective layer or layers.

5. An identification card according to claim 1, wherein the graphic identification information is contained in the composition of the respective layer or layers (7, 8, 12).

6. An identification card according to claim 1, wherein the graphic identification information is contained in the shape and/or intensity of the electrical field in the respective layers as effected by the electrical source, and the electrical current through the respective layers as effected by the electrical source, respectively.

7. An identification card according to claim 1, comprising an internal electrical source connectible with the light emission means.

8. An identification card according to claim 1, comprising means (3) for connecting an external electrical source with the light emission means.

9. An identification system, comprising means (17, 18) for detecting the identification information emitted by the light emission means of an identification card according to claim 1.
